(19) United States
(12) Patent Application Publication
(10) Pub. No.: US 2018/0104915 A1
(43) Pub. Date: Apr. 19, 2018

(54) STACKED FLEXIBLE SUBSTRATE AND METHOD FOR MANUFACTURING THE SAME

(71) Applicant: WUHAN CHINA STAR OPTOELECTRONICS TECHNOLOGY CO., LTD., Wuhan (CN)

(72) Inventor: Zhe LIU, Wuhan (CN)

(21) Appl. No.: 15/302,961

(22) PCT Filed: Apr. 22, 2016
(86) PCT No.: PCT/CN2016/080029

§ 371 Date: Oct. 7, 2016

(30) Foreign Application Priority Data
Mar. 30, 2016 (CN) 201610191158.0

(51) Int. Cl. B29C 69/02; B32B 3/30; B32B 3/26; B32B 27/08; B29C 39/12; B29C 59/04

(52) U.S. Cl. CPC B29C 69/02; B32B 3/30; B32B 3/263; B29K 2079/08; B29C 39/123; B29C 59/046; B32B 2457/20; B32B 27/08

(57) ABSTRACT

A stacked flexible substrate for use in a flexible display panel and method for manufacturing the same are provided. The method comprises the following steps of: coating a first organic layer on a substrate, and forming a plurality of first grooves on the first organic layer; disposing a first inorganic layer on the first organic layer; coating a second organic layer on the first inorganic layer, and forming a plurality of second grooves on the second organic layer; disposing a second inorganic layer on the second organic layer; coating a planarizing layer on the second inorganic layer; and peeling the substrate from the first organic layer.

### FIELD OF THE INVENTION

The present invention relates to the field of display technologies, and more particularly to a stacked flexible substrate and method for manufacturing the same.

### BACKGROUND OF THE INVENTION

The stacked flexible structure is commonly used in the flexible substrate. Namely, the organic-inorganic-organic-inorganic stacked film is used as the flexible substrate for improving the ability of the display substrate against water and oxygen. The conventional stacked flexible substrate may occur: (1) the breakage of the film surface caused by the stress accumulation of inorganic thin film; (2) the film surface error-peeling off caused by the insufficient interfacial adhesion between the organic film and inorganic film.

Therefore, it is necessary to solve the above drawbacks existing in the prior art.

### SUMMARY OF THE INVENTION

An object of the present invention is to provide a stacked flexible substrate and method for manufacturing the same which can solve a technical problem of the breakage of the film surface caused by the stress accumulation of inorganic thin film the conventional inorganic thin film.

In order to solve the aforementioned drawbacks of the prior art, the present invention provides the following technical solutions.

The present invention provides method for manufacturing a stacked flexible substrate, comprising the following steps of:

coating a first organic layer on a substrate, and forming a plurality of first grooves on the first organic layer;

disposing a first inorganic layer on the first organic layer, a maximum thickness of the first inorganic layer is less than a minimum depth of the first groove;

coating a second organic layer on the first inorganic layer, and forming a plurality of second grooves on the second organic layer;

disposing a second inorganic layer on the second organic layer, a maximum thickness of the second inorganic layer is less than a minimum depth of the second groove;

coating a planarizing layer on the second inorganic layer; and
peeling the substrate from the first organic layer.

In the method for manufacturing the stacked flexible substrate described above, the depth of the first grooves is the same, the thickness of the first inorganic layer is uniformity, and the depth of the second grooves is the same, the thickness of the second inorganic layer is uniformity.

In the method for manufacturing the stacked flexible substrate described above, the plurality of first grooves are respectively corresponding to the plurality of second grooves, each of the first grooves is aligned with the corresponding second groove and extended along the same direction therewith, and has the same shape and size as the corresponding second groove.

In the method for manufacturing the stacked flexible substrate described above, all of the first organic layer, the second organic layer, and planarizing layer are polyimide fiber layers.

In the method for manufacturing the stacked flexible substrate described above, the plurality of first grooves are arranged in accordance with a rectangular array arrangement and the plurality of second grooves is arranged in accordance with a rectangular array arrangement.

In the method for manufacturing the stacked flexible substrate described above, the step of forming the plurality of first grooves on the first organic layer comprises: performing a patterning process on the first organic layer for forming the plurality of first grooves through a roll to roll embossing method.

In the method for manufacturing the stacked flexible substrate described above, the step of forming the plurality of second grooves on the second organic layer comprises: performing a patterning process on the second organic layer for forming the plurality of second grooves through a roll to roll embossing method.

In another embodiment of the present invention further provides a stacked flexible substrate, comprising:

a first organic layer, a plurality of first grooves are formed thereon;

a first inorganic layer deposited on the first organic layer, a maximum thickness of the first inorganic layer is less than a minimum depth of the first groove;

a second organic layer deposited on the first inorganic layer, a plurality of second grooves is formed on the second inorganic layer;

a second inorganic layer deposited on the second organic layer, a maximum thickness of the second inorganic layer is less than a minimum depth of the second groove; and

a planarizing layer deposited on the second inorganic layer.

In the stacked flexible substrate described above, all of the first organic layer, the second organic layer, and planarizing layer are polyimide fiber layers.

In the stacked flexible substrate described above, the first grooves are arranged in accordance with a rectangular array arrangement and the second grooves are arranged in accordance with a rectangular array arrangement.

In comparison with the conventional technology, the stacked flexible substrate and method for manufacturing the stacked flexible substrate of the present invention can reduce the probability of the stress accumulation and reduce the physical length of the actual cumulative stress in the direction of applying force while the stacked flexible substrate is bent through performing the patterning process on a first organic layer and a second organic layer for forming the first grooves and the second grooves. Moreover, since the first organic layer can contact with the second organic layer through the inner wall of the first groove, and the second organic layer can contact with planarizing layer through the inner wall of the second groove, the adhesion force between the first organic layer and the second organic layer is increased and the possibility of the film surface peeling off in the following process is reduced. Furthermore, due to the organic-inorganic patterned structure, the pliability of the stacked flexible substrate is increased, so as to make a display substrate bending for a smaller curvature radius.

To make the above embodiments of the invention more comprehensible, the preferred embodiments being adopted by the present invention to achieve the above and other objectives can be best understood by referring to the following detailed description of the preferred embodiments and the accompanying drawings as detailed below.

### DESCRIPTION OF THE DRAWINGS

FIG. 1 is a structural schematic view of a stacked flexible substrate according to a preferred embodiment of the present invention;

FIG. 2 is a structural schematic view of the stacked flexible substrate according to another preferred embodiment of the present invention;

FIG. 3 is a flowchart of a method for manufacturing the stacked flexible substrate according to a preferred embodiment of the present invention; and

FIGS. 4A-4H are manufacturing schematic views of the method for manufacturing the stacked flexible substrate according to the preferred embodiment of the present invention.

### DETAILED DESCRIPTION OF THE PREFERRED EMBODIMENTS

This description of the exemplary embodiments is intended to be read in connection with the accompanying drawings, which are to be considered part of the entire written description. In the description, terms such as “lower”, “upper”, “horizontal”, “vertical”, “above”, “below”, “up”, “down”, “top”, and “bottom”, as well as derivatives thereof should be construed to refer to the orientation as then described or as shown in the drawing under discussion. These terms are for convenience of description and do not require that the apparatus be constructed or operated in a particular orientation, and do not limit the scope of the invention.

Referring now in more detail to the drawings in which like numerals indicate corresponding parts throughout the drawings.

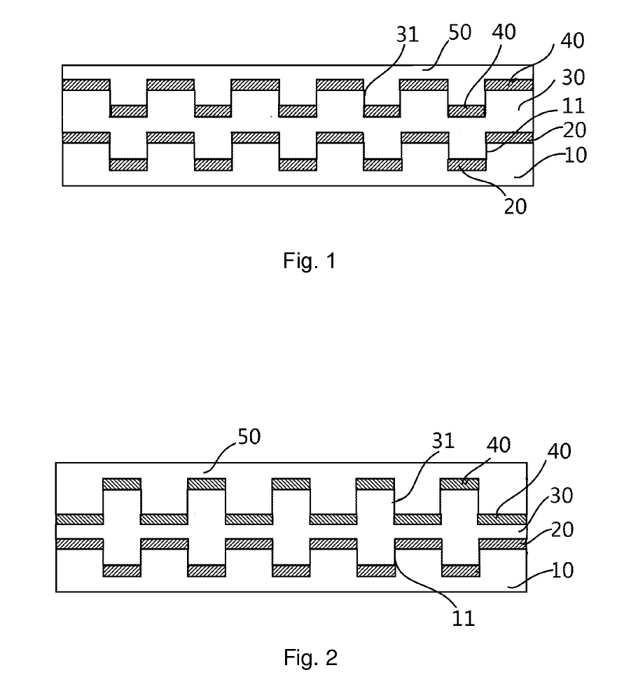

Refer to FIG. 1, which is a structural schematic view of a stacked flexible substrate according to a preferred embodiment of the present invention. The stacked flexible substrate according to a preferred embodiment comprises: a first organic layer 10, a first inorganic layer 20, a second organic layer 30, a second inorganic layer 40, and a planarizing layer 50.

The first organic layer 10 is a polyimide fiber layer. A patterning process is performed on the first organic layer 10 for forming a plurality of first grooves 11 through an embossing method. The embossing method can be a Macro/Nano imprint method or a roll to roll embossing method. Preferably, in the preferred embodiment of the present invention, the depths and shape of the first grooves 11 are the same, and certainly may be different. Moreover, the first grooves 11 are arranged in accordance with a rectangular array arrangement.

The first inorganic layer 20 is deposited on the first organic layer 10 through a thin film deposition method. A maximum thickness of the first inorganic layer 20 is less than a minimum depth of the first groove 11, so that the first organic layer 10 and the second organic layer 30 can contact with each other via a side wall of the first grooves 11. In the embodiment of the present invention, the thickness of the entire first inorganic layer 20 is uniform and equal.

The second organic layer 30 is a polyimide fiber layer which is deposited on the first inorganic layer 20. A patterning process is performed on the second organic layer 30 for forming a plurality of second grooves 31 through an embossing method. The embossing method can be a Macro/Nano imprint method or a roll to roll embossing method. Preferably, in the preferred embodiment of the present invention, the depths and shape of the second grooves 31 are the same, certainly may be different. Moreover, the second grooves 31 are arranged in accordance with a rectangular array arrangement.

The second inorganic layer 40 is deposited on the second organic layer 30 through a thin film deposition method. A maximum thickness of the second inorganic layer 40 is less than a minimum depth of the second groove 31, so that the second organic layer 30 and the planarizing layer 50 can contact with each other via a side wall of the second grooves 31. In the embodiment of the present invention, the thickness of the entire second inorganic layer 40 is uniform and equal.

The planarizing layer 50 is a polyimide fiber layer which is deposited on the second inorganic layer 40.

The stacked flexible substrate according to the preferred embodiment of the present invention can reduce the probability of the stress accumulation and reduce the physical length of the actual cumulative stress in the direction of applying force while the stacked flexible substrate is bent through performing the patterning process on the first organic layer 10 and the second organic layer 30 for forming the first grooves 11 and the second grooves 31. Moreover, since the first organic layer 10 can contact with the second organic layer 30 through the inner wall of the first groove 11, and the second organic layer 30 can contact with planarizing layer 50 through the inner wall of the second groove 31, the adhesion force between the first organic layer 10 and the second organic layer 30 is increased and the possibility of the film surface peeling off during the use of the stacked flexible substrate is reduced. Furthermore, due to the organic-inorganic patterned structure, the pliability of the stacked flexible substrate is increased, so as to achieve a smaller curvature radius of the bending display substrate.

Preferably, the first grooves 11 are arranged in accordance with a rectangular array arrangement and the second grooves 31 are arranged in accordance with a rectangular array arrangement.

The pattern formed via the patterning process on the first organic layer 10 is the same as the pattern formed on the second organic layer 30. Namely, the first grooves 11 are respectively corresponding to the second grooves 31, each of the first grooves 11 is aligned with the corresponding second groove 31 and extended along the same direction therewith, and has the same shape and size as the corresponding second groove 31.

Specifically, it can be understood that the pattern formed via the patterning process on the first organic layer 10 can differ from the pattern formed on the second organic layer 30 as shown in FIG. 2. The first grooves 11 are respectively corresponding to the second grooves 31, each of the first grooves 11 is aligned with the corresponding second groove 31 and extended along the opposite direction thereto, and has the same shape and size as the corresponding second groove 31.

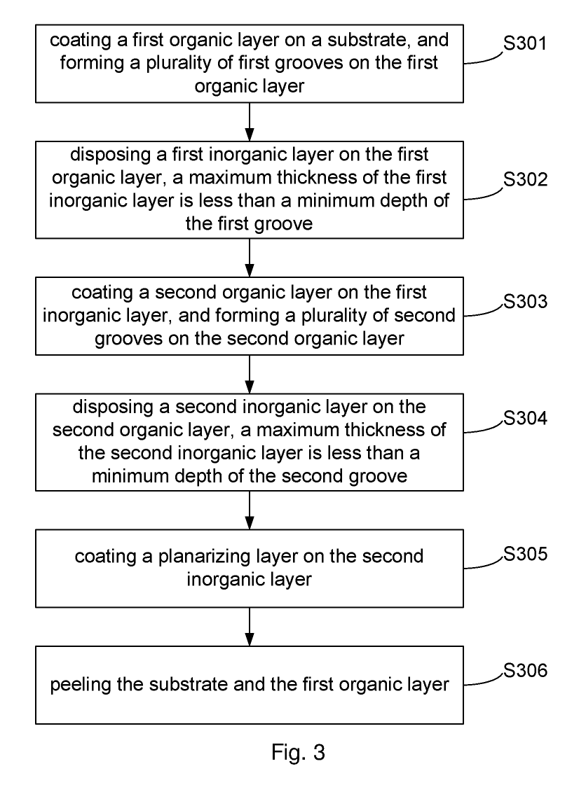

Refer to FIG. 3, which is a flowchart of a method for manufacturing the stacked flexible substrate according to a preferred embodiment of the present invention. The method for manufacturing the stacked flexible substrate comprises the following steps of:

S301, coating a first organic layer on a substrate, and forming a plurality of first grooves on the first organic layer;

S302, disposing a first inorganic layer on the first organic layer, wherein a maximum thickness of the first inorganic layer is less than a minimum depth of the first groove;

S303, coating a second organic layer on the first inorganic layer, and forming a plurality of second grooves on the second organic layer;

S304, disposing a second inorganic layer on the second organic layer, wherein a maximum thickness of the second inorganic layer is less than a minimum depth of the second groove;

S305, coating a planarizing layer on the second inorganic layer; and

S306, peeling the substrate from the first organic layer.

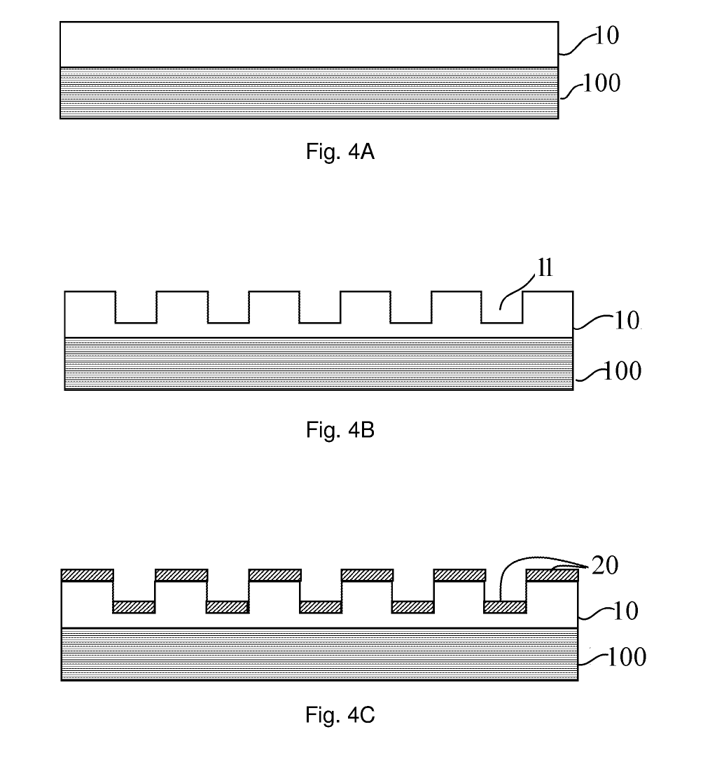

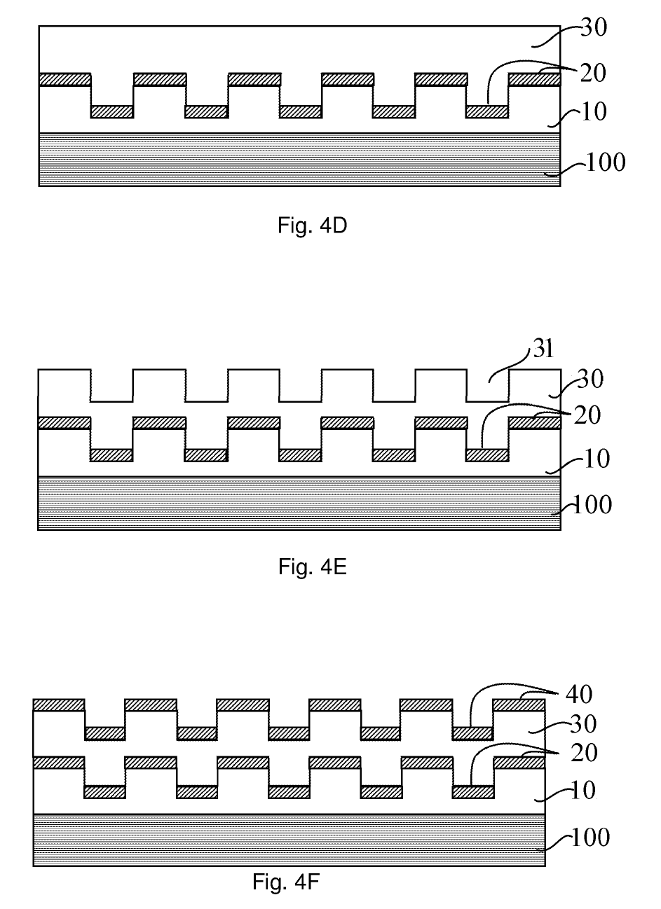

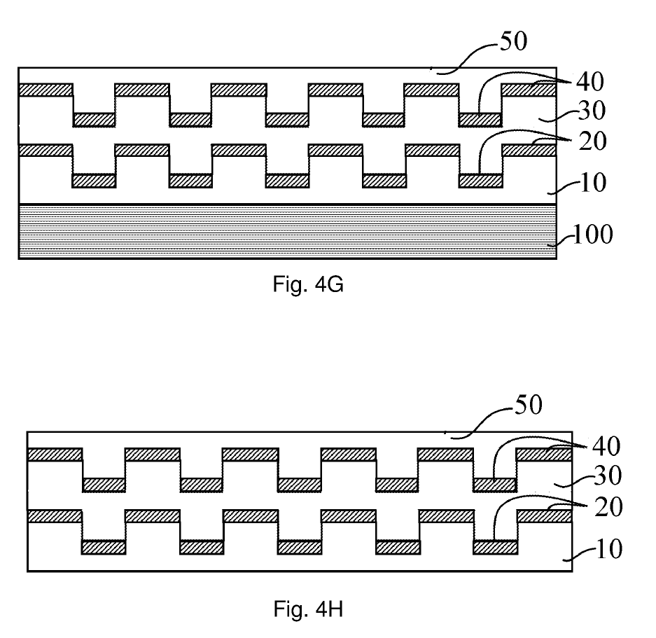

The following FIGS. 4A-4H describe each of the steps of the method in detail.

In the step S301, the first organic layer 10 is a polyimide fiber layer and is coated on the substrate 100. The step of forming the first grooves on the first organic layer comprises: performing a patterning process on the first organic layer for forming the plurality of first grooves through an embossing method. The embossing method can be a Macro/Nano imprint method or a roll to roll embossing method. Preferably, in the preferred embodiment of the present invention, the depths and shape of the first grooves 11 are the same. Moreover, the first grooves 11 are arranged in accordance with a rectangular array arrangement as shown in FIGS. 4A-4B, and then proceed to step S302.

In the step S302, a thin film deposition method can be employed to deposit the first inorganic layer 20 on the first organic layer 10. A maximum thickness of the first inorganic layer 20 is less than a minimum depth of the first groove 11, so that the first organic layer 10 and the second organic layer 30 can contact with each other via a side wall of the first grooves 11. In the embodiment of the present invention, the thickness of the entire first inorganic layer 20 is uniform and equal as shown in FIG. 4C, and then proceed to step S303.

In the step S303, the second organic layer 30 is a polyimide fiber layer which is deposited on the first inorganic layer 20. A patterning process is performed on the second organic layer 30 for forming a plurality of second grooves 31 through an embossing method. The embossing method can be a Macro/Nano imprint method or a roll to roll embossing method. Preferably, in the preferred embodiment of the present invention, the depths and shape of the second grooves 31 are the same, and certainly may be different. Moreover, the second grooves 31 are arranged in accordance with a rectangular array arrangement as shown in FIG. 4D and FIG. 4E, and then goes to step S304.

In the step S304, the second inorganic layer 40 is deposited on the second organic layer 30 through a thin film deposition method. A maximum thickness of the second inorganic layer 40 is less than a minimum depth of the second groove 31, so that the second organic layer 30 and the planarizing layer 50 can contact with each other via a side wall of the second grooves 31. In the embodiment of the present invention, the thickness of the entire second inorganic layer 40 is uniform and equal as shown in FIG. 4F, and then proceed to step S305.

In the step S305, the planarizing layer 50 is a polyimide fiber layer, as shown in FIG. 4G, and then proceed to step S306.

After finishing the step S305, a display layer is disposed on the planarizing layer 50.

In the step S306, the substrate 100 is stripped from the first organic layer 10 of the stacked flexible substrate through a Laser-Lift-Off technology, as shown in FIG. 4H, so that a flexible display panel with the stacked flexible substrate can be made.

The stacked flexible substrate according to the preferred embodiment of the present invention can reduce the probability of the stress accumulation and reduce the physical length of the actual cumulative stress in the direction of applying force while the stacked flexible substrate is bent through performing the patterning process on the first organic layer 10 and the second organic layer 30 for forming the first grooves 11 and the second grooves 31. Moreover, since the first organic layer 10 can contact with the second organic layer 30 through the inner wall of the first groove 11, and the second organic layer 30 can contact with planarizing layer 50 through the inner wall of the second groove 31, the adhesion force between the first organic layer 10 and the second organic layer 30 is increased and the possibility of the film surface peeling off in the following use of the stacked flexible substrate is reduced. Furthermore, due to the organic-inorganic patterned structure, the pliability of the stacked flexible substrate is increased, so as to achieve a smaller curvature radius of the bending display substrate.

The present invention has been described with preferred embodiments thereof, and it is understood that many changes and modifications to the described embodiments can be carried out without departing from the scope and the spirit of the invention that is intended to be limited only by the appended claims.

1. A method for manufacturing a stacked flexible substrate, comprising the following steps of:
coating a first organic layer on a substrate, and forming a plurality of first grooves on the first organic layer;
disposing a first inorganic layer on the first organic layer, wherein a maximum thickness of the first inorganic layer is less than a minimum depth of the first groove;
coating a second organic layer on the first inorganic layer, and forming a plurality of second grooves on the second organic layer;
disposing a second inorganic layer on the second organic layer, wherein a maximum thickness of the second inorganic layer is less than a minimum depth of the second groove;
coating a planarizing layer on the second inorganic layer; and
peeling the substrate from the first organic layer.

2. The method for manufacturing the stacked flexible substrate according to claim 1, wherein the depth of the first grooves is the same, the thickness of the first inorganic layer is uniformity, and the depth of the second grooves is the same, the thickness of the second inorganic layer is uniformity.

3. The method for manufacturing the stacked flexible substrate according to claim 2, wherein the plurality of first grooves are respectively corresponding to the plurality of second grooves, each of the first grooves is aligned with the corresponding second groove and extended along the same direction therewith, and has the same shape and size as the corresponding second groove.

4. The method for manufacturing the stacked flexible substrate according to claim 1, wherein all of the first organic layer, the second organic layer and planarizing layer are polyimide fiber layers.

5. The method for manufacturing the stacked flexible substrate according to claim 1, wherein the plurality of first grooves are arranged in accordance with a rectangular array arrangement and the plurality of second grooves are arranged in accordance with a rectangular array arrangement.

6. The method for manufacturing the stacked flexible substrate according to claim 1, wherein the step of forming the plurality of first grooves on the first organic layer comprises:
performing a patterning process on the first organic layer for forming the plurality of first grooves through a roll to roll embossing method.

7. The method for manufacturing the stacked flexible substrate according to claim 1, wherein the step of forming the plurality of second grooves on the second organic layer comprises:
performing a patterning process on the second organic layer for forming the plurality of second grooves through a roll to roll embossing method.

8. A stacked flexible substrate, comprising:
a first organic layer, a plurality of first grooves is formed thereon;
a first inorganic layer deposited on the first organic layer, wherein a maximum thickness of the first inorganic layer is less than a minimum depth of the first groove;
a second organic layer deposited on the first inorganic layer, a plurality of second grooves is formed on the second inorganic layer;
a second inorganic layer deposited on the second organic layer, wherein a maximum thickness of the second inorganic layer is less than a minimum depth of the second groove; and
a planarizing layer deposited on the second inorganic layer.

9. The stacked flexible substrate according to claim 8, wherein all of the first organic layer, the second organic layer, and planarizing layer are polyimide fiber layers.

10. The stacked flexible substrate according to claim 8, wherein the plurality of first grooves is arranged in accordance with a rectangular array arrangement and the plurality of second grooves is arranged in accordance with a rectangular array arrangement.

11. A stacked flexible substrate, comprising:
a first organic layer, a plurality of first grooves are formed thereon;
a first inorganic layer deposited on the first organic layer, wherein a maximum thickness of the first inorganic layer is less than a minimum depth of the first groove;
a second organic layer deposited on the first inorganic layer, a plurality of second grooves are formed on the second inorganic layer;
a second inorganic layer deposited on the second organic layer, wherein a maximum thickness of the second inorganic layer is less than a minimum depth of the second groove;
a planarizing layer deposited on the second inorganic layer;
wherein the depth of the first grooves is the same, the thickness of the first inorganic layer is uniformity, and the depth of the second grooves is the same, the thickness of the second inorganic layer is uniform;
wherein the plurality of first grooves is respectively corresponding to the plurality of second grooves, each of the first grooves is aligned with the corresponding second groove and extended along the same direction therewith, and has the same shape and size as the corresponding second groove; and
wherein all of the first organic layer, the second organic layer, and planarizing layer are polyimide fiber layers.
